(19) United States
(12) Patent Application Publication
(10) Pub. No.: US 2023/0074819 A1
(43) Pub. Date: Mar. 9, 2023

(54) Authentication Question Generation Based on Statement Availability

(71) Applicant: Capital One Services, LLC, McLean, VA (US)

(72) Inventors: Samuel Rapowitz, Roswell, GA (US); Joshua Edwards, Philadelphia, PA (US); Tyler Maiman, Melville, NY (US); Viraj Chaudhary, Katy, TX (US); Daniel Miller, Astoria, NY (US); David Septimus, New York, NY (US); Jenny Melendez, Falls Church, VA (US)

(21) Appl. No.: 17/468,857

(22) Filed: Sep. 8, 2021

(51) Int. Cl. G06Q 20/40; H04L 12/58

(52) U.S. Cl. CPC G06Q 20/409; G06Q 20/4015; H04L 51/34

(57) ABSTRACT

Methods, systems, and apparatuses are described herein for improving computer authentication processes by generating authentication questions based on the availability of statements. A computing device may receive a request for access to an account. The computing device may receive transactions data that indicates a plurality of transactions. The computing device may determine that a first subset of the plurality of transactions were indicated in one or more statements sent to the user. The computing device may determine that a second subset of the plurality of transactions have not been indicated in the one or more statements sent to the user. The computing device may generate authentication questions based on the first subset and the second subset. The computing device may receive candidate responses to the authentication questions, and provide access to the account based on the candidate responses.

### FIELD OF USE

Aspects of the disclosure relate generally to account security. More specifically, aspects of the disclosure may provide for improvements in the method in which authentication questions are generated based on whether data has been provided to a user in, e.g., an electronic or printed statement.

### BACKGROUND

As part of determining whether to grant a user access to content (e.g., as part of determining whether to provide a caller access to a telephone system that provides banking information), a user of the user device may be prompted with one or more authentication questions. Such questions may relate to, for example, a password of the user, a personal identification number (PIN) of the user, or the like. Those questions may additionally and/or alternatively be generated based on personal information of the user. For example, when setting up an account, a user may provide a variety of answers to predetermined questions (e.g., “Where was your father born?,” “Who was your best friend in high school?”), and those questions may be presented to the user as part of an authentication process. As another example, a commercially-available database of personal information may be queried to determine personal information for a user (e.g., their birthdate, birth location, etc.), and that information may be used to generate an authentication question (e.g., “Where were you born, and in what year?”). A potential downside of these types of authentication questions is that the correct answers may be obtainable and/or guessable for someone who has information about a particular user.

As part of authenticating a computing device, information about financial transactions conducted by a user of that computing device may be used to generate authentication questions as well. For example, a user may be asked questions about one or more transactions conducted by the user in the past (e.g., “Where did you get coffee yesterday?,” “How much did you spend on coffee yesterday?,” or the like). Such questions may prompt a user to provide a textual answer (e.g., by inputting an answer in a text field), to select one of a plurality of answers (e.g., select a single correct answer from a plurality of candidate answers), or the like. In some instances, the user may be asked about transactions that they did not conduct. For example, a computing device may generate a synthetic transaction (that is, a fake transaction that was never conducted by a user), and ask a user to confirm whether or not they conducted that transaction. Authentication questions can be significantly more useful when they can be based on either real transactions or synthetic transactions: after all, if every question related to a real transaction, a nefarious user could use personal knowledge of a legitimate user to guess the answer, and/or the nefarious user may be able to glean personal information about the legitimate user.

Should a malicious user gain access to statements (e.g., printed statements, e-mail statements) of an authorized user, that malicious user may be able to guess the answer to authentication questions, even if those authentication questions are particularly difficult or complicated. For example, if a malicious user steals the mail of an authorized user, that malicious user may gain access to a printed financial statement which indicates one or more transactions which the authorized user conducted over a period of time. Using that financial statement, the malicious user may be able to answer (e.g., guess the answers to) authentication questions for financial accounts associated with the authorized user, thereby potentially gaining access to the authorized user's financial accounts. Similar concerns exist with unauthorized access to e-mail accounts, where electronic statements may be received and/or stored, and/or trash, where an authorized user may discard financial statements and/or receipts.

Aspects described herein may address these and other problems, and generally improve the safety of financial accounts and computer transaction systems by generating and providing authentication questions in a manner which lessens the risk that theft (e.g., of printed and/or electronic statements and/or trash) could provide answers to those authentication questions.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for improvements in the manner in which authentication questions are used to control access to accounts. The improvements described herein relate to generating authentication questions in a manner that prevents a malicious user from using a maliciously-acquired statement (e.g., a stolen printed financial statement and/or an electronic financial statement that was maliciously acquired) to gain access to accounts of an authorized user. To perform this process, a computing device may determine subsets of a plurality of transactions. While some of those subsets may comprise transactions that have not been reported in a statement (e.g., very recent transactions), other subsets may correspond to transactions that have been reported in one or more of a plurality of statements. The computing device may then generate questions based on the subsets, such that a single (potentially stolen) financial statement does not provide access to an account. For example, a user may be prompted to answer authentication questions relating to very recent transactions (e.g., those not reflected in a statement) as well as transactions that each were reported in a different statement.

More particularly, some aspects described herein may provide for a computing device that may receive, from a user device, a request for access to an account associated with a user. The computing device may receive, from a transactions database, transactions data corresponding to the account, wherein the transactions data indicates a plurality of transactions conducted by the user. The computing device may determine that a first subset of the plurality of transactions were indicated in one or more statements sent to the user. The one or more statements may comprise one or more of: paper statements mailed to the user, and/or electronic statements transmitted to the user. The computing device may determine that a second subset of the plurality of transactions have not been indicated in the one or more statements sent to the user; generate a first authentication question associated with a first transaction of the first subset of the plurality of transactions. The computing device may generate a second authentication question associated with a second transaction of the second subset of the plurality of transactions. The first authentication question may correspond to a first merchant that is not indicated in the second subset of the plurality of transactions, whereas the second authentication question may correspond to a second merchant that is not indicated in the first subset of the plurality of transactions. The computing device may receive a first candidate response to the first authentication question; receive a second candidate response to the second authentication question. The computing device may provide, based on the first candidate response and the second candidate response, the user device access to the account.

The computing device may determine one or more subsets by estimating when a statement may have been available (e.g., to an authorized user, to a thief, or the like). For example, as part of determining that the first subset of the plurality of transactions were indicated in the one or more statements sent to the user, the computing device may estimate, based on a location of the user, that the user has received the one or more statements. This estimation may be performed by estimating a time that the user received the one or more statements. For example, the computing device may determine a mailing time of a transaction card, determine an activation time of the transaction card, and determine, based on comparing the mailing time and the activation time, a mailing delay. The computing device may then determine a second mailing time associated with the one or more statements. The computing device may then determine a predicted time when the user is predicted to have received the one or more statements based on comparing the second mailing time and the mailing delay. Additionally and/or alternatively, the computing device may determine that the first subset of the plurality of transactions were indicated in the one or more statements sent to the user by determining that an e-mail comprising the one or more statements was opened. Additionally and/or alternatively, the computing device may determine that the first subset of the plurality of transactions were indicated in the one or more statements sent to the user by receiving an indication that the one or more statements have been stolen.

The aforementioned process may be repeated for multiple authentication questions, such that the authentication questions may correspond to different subsets of the plurality of transactions. In this manner, while one authentication question may pertain to a new transaction (e.g., that has not yet been reported in a statement), a second authentication statement may have been reported in a first statement, a third authentication question may have been reported in a second statement, and so forth. For example, the computing device may determine that a third subset of the plurality of transactions were indicated in one or more second statements sent to the user. In such a circumstance, the one or more second statements may correspond to a different time period as compared to the one or more statements referenced in the paragraph above. The computing device may generate a third authentication question associated with a third transaction of the third subset of the plurality of transactions. Then, the computing device may receive a third candidate response to the third authentication question. The computing device may provide the user device access to the account further based on the third candidate response.

Corresponding method, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts a flow chart comprising steps which may be performed for generating and presenting authentication questions by determining subsets of transactions;

FIG. 5 depicts examples of statements; and

FIG. 6 depicts examples of authentication questions.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving authentication questions used during an authentication process. In particular, the process depicted herein may analyze the availability of statements (e.g., printed and/or electronic financial statements) when generating authentication questions in a manner that prevents the potential theft of (and/or unauthorized access to) those statements from providing a malicious user access to an account.

As an example of one problem addressed by the current disclosure, an authentication system may, as part of an authentication process for accessing an account, generate and present an authentication question, such as “Where did you shop in July?” This authentication question may be particularly strong, as it would be difficult for those other than an authorized user to answer. That said, if a malicious user were to steal the authorized user's mail, the malicious user may gain access to a financial statement for July, thereby allowing the malicious user to look up the answer to the authentication question. The malicious user may also be able to accomplish this feat by gaining unauthorized access to the authorized user's e-mail account (where an electronic financial statement may have been mailed), and/or by stealing the authorized user's trash (where a printed financial statement may have been thrown away). In turn, a physical security issue (e.g., the ability of a malicious user to steal an authorized user's mail or trash) could quickly become an electronic security issue (e.g., the ability of the malicious user to later access electronic accounts of the authorized user).

The process described herein remedies the above problem (among others) by determining subsets of a plurality of transactions. Each of those subsets may correspond to one or more different statements or, in some instances, no statements (e.g., in the case of cancelled transactions and/or very new transactions that have not yet been put into a statement). Indeed, as will be described in more detail below, each subset may be based on whether a user (and/or a malicious user) is predicted to have access to the statement. Authentication questions may be then generated based on transactions from different subsets of the plurality of transactions. In this manner, the authentication questions may be sufficiently varied such that, even if a malicious user gains unauthorized access to one or more statements, the likelihood that the malicious user can answer all authentication questions is low.

Aspects described herein improve the functioning of computers by improving the way in which computers provide authentication questions and protect computer-implemented accounts. The speed and processing complexity of computing devices allows them to present more complicated authentications than ever before, which advantageously can improve the security of sensitive account information. That said, the algorithms with which authentication questions are generated can have security holes, which may render those authentication questions undesirably vulnerable to exploitation. Such exploitation can result in the illegitimate use and abuse of computer resources. The processes described herein improve this process by generating and presenting authentication questions in a manner which prevents malicious activity (e.g., mail theft) from creating an unexpected security vulnerability. Such steps cannot be performed by a user and/or via pen and paper at least because the problem is fundamentally rooted in computing processes, involves a significantly complex amount of data and word processing, and requires steps (e.g., authenticating computerized requests for access) which cannot be performed by a human being.

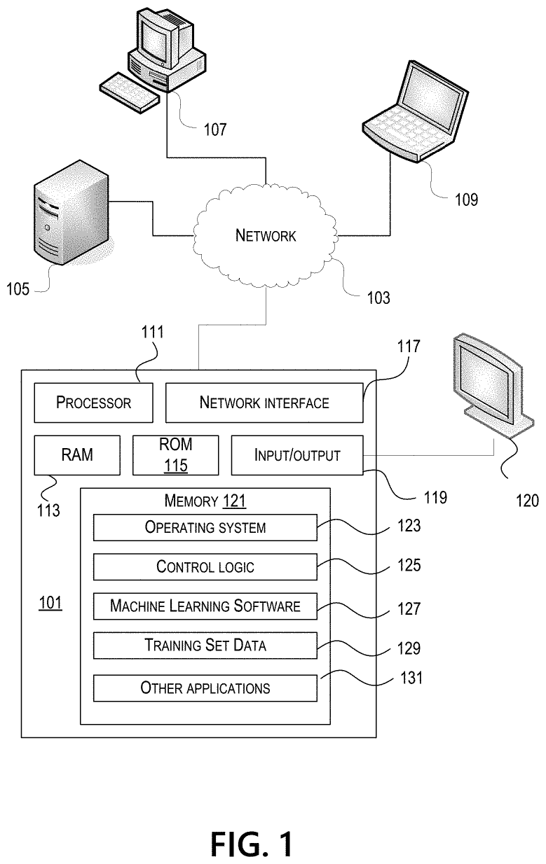

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

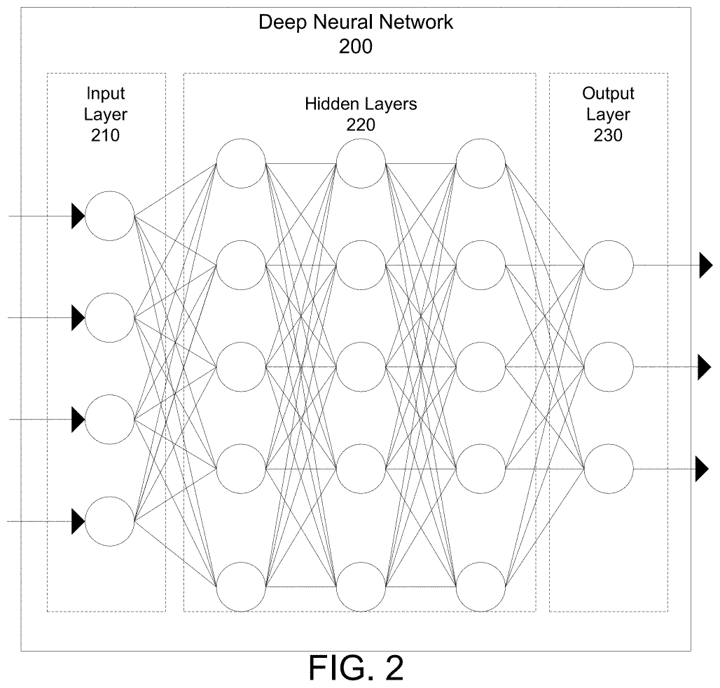

FIG. 2 illustrates an example deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

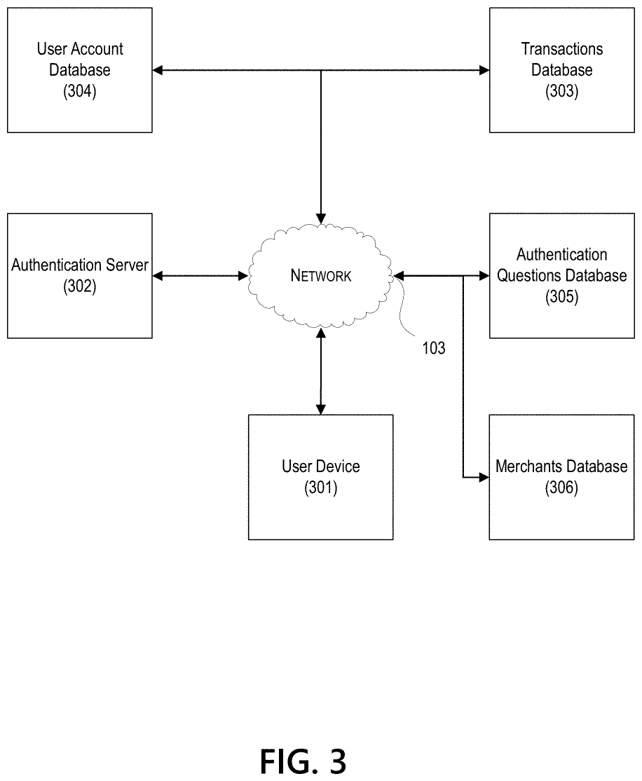

FIG. 3 depicts a system for authenticating a user device 301. The user device 301 is shown as connected, via the network 103, to an authentication server 302, a transactions database 303, a user account database 304, an authentication questions database 305, and a merchants database 306. The network 103 may be the same or similar as the network 103 of FIG. 1. Each of the user device 301, the authentication server 302, the transactions database 303, the user account database 304, the authentication questions database 305, and/or the merchants database 306 may be implemented on one or more computing devices, such as a computing device comprising one or more processors and memory storing instructions that, when executed by the one or more processors, perform one or more steps as described further herein. For example, any of those devices may be the same or similar as the computing devices 101, 105, 107, and 109 of FIG. 1.

As part of an authentication process, the user device 301 may communicate, via the network 103, to access the authentication server 302 to request access (e.g., to a user account). The user device 301 shown here may be a smartphone, laptop, or the like, and the nature of the communications between the two may be via the Internet, a phone call, or the like. For example, the user device 301 may access a website associated with the authentication server 302, and the user device 301 may provide (e.g., over the Internet and by filling out an online form) candidate authentication credentials to that website. The authentication server 302 may then determine whether the authentication credentials are valid. For example, the authentication server 302 may compare the candidate authentication credentials received from the user device 301 with authentication credentials stored by the user account database 304. In the case where the communication is telephonic, the user device 301 need not be a computing device, but may be, e.g., a conventional telephone.

The user account database 304 may store information about one or more user accounts, such as a username, password, demographic data about a user of the account, or the like. For example, as part of creating an account, a user may provide a username, a password, and/or one or more answers to predetermined authentication questions (e.g., “What is the name of your childhood dog?”), and this information may be stored by the user account database 304. The authentication server 302 may use this data to generate authentication questions. The user account database 304 may store demographic data about a user, such as their age, gender, location, occupation, education level, income level, and/or the like.

The transactions database 303 may comprise data relating to one or more transactions conducted by one or more financial accounts associated with a first organization. For example, the transactions database 303 may maintain all or portions of a general ledger for various financial accounts associated with one or more users at a particular financial institution. The data stored by the transactions database 303 may indicate one or more merchants (e.g., where funds were spent), an amount spent (e.g., in one or more currencies), a date and/or time (e.g., when funds were spent), or the like. The data stored by the transactions database 303 may be generated based on one or more transactions conducted by one or more users. For example, a new transaction entry may be stored in the transactions database 303 based on a user purchasing an item at a store online and/or in a physical store. As another example, a new transaction entry may be stored in the transactions database 303 based on a recurring charge (e.g., a subscription fee) being charged to a financial account.

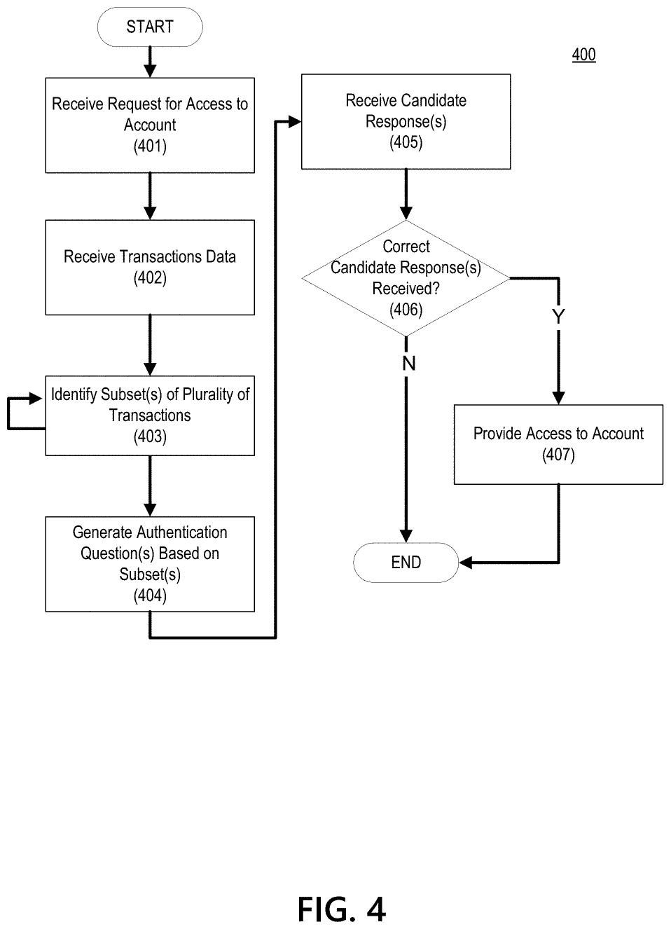

The one or more transactions stored in the transactions database 303 may have been indicated in statements sent to a user. A statement may comprise any message (e.g., physical printed mail, e-mail, text message) which indicates one or more transactions. For example, a statement may comprise a printed physical letter, sent to an authorized user of an account, that indicates one or more transactions conducted over a period of time (e.g., thirty days, a particular month, a quarter, or the like). The statements need not be in any particular format. For example, and as will be described further below with respect to FIG. 4, aspects described herein apply equally regardless of how often statements are sent, how many transactions are involved, or the like.

The account data stored by the user account database 304 and the transactions database 303 may, but need not be related. For example, the account data stored by the user account database 304 may correspond to a user account for a bank website, whereas the financial account data stored by the transactions database 303 may be for a variety of financial accounts (e.g., credit cards, checking accounts, savings accounts) managed by the bank. As such, a single user account may provide access to one or more different financial accounts, and the accounts need not be the same. For example, a user account may be identified by a username and/or password combination, whereas a financial account may be identified using a unique number or series of characters.

The authentication questions database 305 may comprise data which enables the authentication server 302 to present authentication questions. An authentication question may be any question presented to one or more users to determine whether the user is authorized to access an account. For example, the question may be related to personal information about the user (e.g., as reflected by data stored in the user account database 304), may be related to past transactions of the user (e.g., as reflected by data stored by the transactions database 303), or the like. With respect to personal information, the question may relate to some aspect of the personal information of the user that may change (and may therefore be harder for a malicious entity to learn), such as their street address, where they currently work, or the like. With respect to past transactions of the user, the question may relate to recent transactions, such as those which may have been recently conducted by an authorized user but which might not yet be reflected in printed bank account statements (which may be stolen by a malicious entity). The authentication questions database 305 may comprise data for one or more templates which may be used to generate an authentication question based on real information (e.g., from the user account database 304 and/or the transactions database 303) and/or based on synthetic information (e.g., synthetic transactions which have been randomly generated and which do not reflect real transactions). An authentication question may correspond to a synthetic transaction (e.g., a transaction which never occurred). For example, a synthetic transaction indicating a $10 purchase at a coffee shop on Wednesday may be randomly generated, and the authentication question could be, e.g., “Where did you spent $10 last Wednesday?,” “How much did you spend at the coffee shop last Wednesday?,” or the like. In all such questions, the correct answer may indicate that the user never conducted the transaction. As part of generating authentication questions based on synthetic transactions, organizations may be randomly selected from a list of organizations stored by the merchants database 306. Additionally and/or alternatively, as part of generating such authentication questions based on synthetic transactions, real transactions (e.g., as stored in the transactions database 303) may be analyzed. In this manner, real transactions may be used to make synthetic transactions appear more realistic. The authentication questions database 305 may additionally and/or alternatively comprise historical authentication questions. For example, the authentication questions database 305 may comprise code that, when executed, randomly generates an authentication question, then stores that randomly-generated authentication question for use with other users.

Authentication questions may be associated with varying levels of difficulty. For example, straightforward answers that should be easily answered by a user (e.g., “What is your mother's maiden name?”) may be considered easy questions, whereas complicated answers that require a user to remember past transactions (e.g., “How much did you spend on coffee yesterday?”) may be considered difficult questions. An authentication process may prompt a user to answer multiple authentication questions. For example, a user may be required to correctly answer three easy authentication questions and/or to answer one hard authentication question.

The merchants database 306 may store data relating to one or more merchants, including indications (e.g., names) of merchants, aliases of the merchants, and the like. That data may be used to generate authentication questions that comprise both correct answers (e.g., based on data from the transactions database 303 indicating one or more merchants where a user has in fact conducted a transaction) and synthetic transactions (e.g., based on data from the merchants database 306, which may be randomly-selected merchants where a user has not conducted a transaction). For example, a computing device may, as part of randomly generating a synthetic transaction using instructions provided by the authentication questions database 305, generate a synthetic transaction by querying the merchants database 306 for a list of merchants, then removing, from that list, organizations represented in the data stored by the transactions database 303.

Having discussed several examples of computing devices which may be used to implement some aspects as discussed further below, discussion will now turn to a method for generating authentication questions during an authentication process in a manner that considers statements that may have been provided to (e.g., sent to) a user.

FIG. 4 illustrates an example method 400 for generating and presenting authentication questions by determining subsets of transactions in accordance with one or more aspects described herein. The method 400 may be implemented by a suitable computing system, as described further herein. For example, the method 400 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 400 may be implemented in suitable program instructions, such as in machine learning software 127, and may operate on a suitable training set, such as training set data 129. The method 400 may be implemented by computer-readable media that stores instructions that, when executed, cause performance of all or portions of the method 400. The steps shown in the method 400 are illustrative, and may be re-arranged or otherwise modified as desired.

In step 401, the computing device may receive a request for access to an account. For example, the computing device may receive, from a user device, a request for access to an account associated with a user. The request may be associated with access, by a user, to a website, an application, or the like. The request may additionally and/or alternatively be associated with, for example, a user device calling into an IVR system or similar telephone response system. For example, the computing device may receive an indication of a request for access to an account responsive to a user accessing a log-in page, calling a specific telephone number, or the like. The request may specifically identify an account via, for example, an account number, a username, or the like. For example, a user may call an IVR system and be identified (e.g., using caller ID) by their telephone number, which may be used to query the user account database 304 for a corresponding account.

In step 402, the computing device may receive transactions data. The transaction data may be received from, e.g., the transactions database 303. The transaction data may correspond to the account referenced in step 401. For example, the computing device may receive, from a transactions database, transactions data corresponding to the account. The transactions data may indicate one or more transactions conducted by the user. For example, the transactions data may comprise indications of purchases of goods and/or services made by a user. The transactions data may correspond to a period of time, such as a recent period of time (e.g., the last two months, the last four months, or the like).

In step 403, the computing device may identify one or more subsets of the plurality of transactions. The subsets may correspond to which statements, if any, a transaction has been reported in. Transactions in the transactions data received in step 402 may have been indicated in one or more statements. For example, a first transaction may have been reported in a first statement, whereas a second transaction may have been reported in a second statement, whereas a third transaction may be so new as to not yet have been reported in a statement, and so forth. In such a circumstance, the subsets determined in step 403 may be determined such that, for example, the first transaction is in a first subset, the second transaction is in a second subset, and the third transaction is in a third subset. Because such statements may correspond to different time periods (e.g., one statement may be for July, another for August), the subsets may broadly correspond to different periods of time. For example, one subset may correspond to a statement for the period of July 1 through July 15, whereas another subset may correspond to another statement for the period of July 16 through July 31. As such, different subsets may correspond to different statements (or no statement at all). For example, the computing device may determine that a first subset of the plurality of transactions were indicated in one or more statements sent to the user, and then determine that a second subset of the plurality of transactions have not been indicated in the one or more statements sent to the user.

Determining the subsets may comprise estimating whether a user has had the opportunity to receive one or more statements. Even though a transaction may be indicated in a statement (e.g., a paper statement mailed to the user at the end of every month), this does not mean that the authorized user will have actually received the paper statement. In turn, if the paper statement has not yet arrived at the authorized user's address, a malicious user will not yet have the opportunity to steal the paper statement. In other words, a statement may be relevant for the purposes of determining a subset only if the statement will have been made available (electronically, physically, or otherwise) to the user in some manner, such that there is a possibility that it may be maliciously acquired in some manner. To determine whether a statement was made available to a user, the computing device may evaluate whether a user has had the opportunity to receive the statement. Such a determination may be made on the location of the user, such that mailing delays are considered. For example, the computing device may estimate, based on a location of the user, that the user has received the one or more statements. In such a circumstance, the location of the user may be compared to, for example, a postal chart indicating average delivery times for one or more locations. Additionally and/or alternatively, such a determination may be made by determining whether electronic content (e.g., an e-mail, a website) has been accessed by the user. For example, if the statement is e-mailed to the user, then the computing device may determine whether the e-mail has been opened using a tracking image or the like (as discussed in further detail below). If a transaction is included in a statement but the authorized user has not yet had the opportunity to receive the statement (such that a malicious user is unlikely to have had the opportunity to steal the statement), the transaction may be grouped in a subset of the plurality of transactions that corresponds to transactions that have not yet been included in a statement. On the other hand, if the transaction has been included in a statement that the authorized user has had the opportunity to receive (such that the malicious user may have had the opportunity to steal the statement), the transaction may be grouped into a subset with other transactions indicated by the statement.

Estimating whether a user has had the opportunity to receive one or more statements may be based on predicting a time when a user will have received a statement. Because different authorized users may live in a variety of different areas, different users may receive mailed content at different times. In turn, the computing device may predict when a particular authorized user has received a statement based on how long it typically takes for mail to reach that authorized user. The determination of such a delay may be made based on other mail, such as content mailed to users in the past. In the case of financial institutions, this may be performed by determining how long it took for a particular authorized user to receive and activate a new transaction card. The computing device may determine a mailing time of a transaction card. For example, the computing device may determine that it previously mailed a particular authorized user a debit card on Monday at 9:00 PM. The computing device may then determine an activation time of the transaction card. For example, the computing device may determine that the debit card was activated on a Thursday at 9:00 AM. The computing device may then determine, based on comparing the mailing time and the activation time, a mailing delay. In the example described above, the computing device may determine that the mailing delay is approximately two days and twelve hours. Such a mailing delay may be approximate: after all, some of the delay may correspond to the user making time to go to their mailbox, take the steps required to activate the card, and the like. As such, the real mailing delay may be around two days, if not less. The computing device may then determine a second mailing time associated with the one or more statements. For example, a new printed account statement may have been mailed on Monday at 9:00 PM. The computing device may then determine a predicted time when the user is predicted to have received the one or more statements based on comparing the second mailing time and the mailing delay. For example, based on the calculations above, the computing device may predict that the account statement may be received sometime Wednesday evening or Thursday morning.

Estimating whether a user has had the opportunity to receive one or more statements may comprise predicting that a user will have the opportunity to receive a statement immediately when that statement is transmitted. Certain methods of transmission (e.g., text messages) may not be configured to track if (and when) a recipient has opened and/or received a message. In such a circumstance, the computing device might predict that a user (whether authorized or malicious) might have access to a message as soon as it is transmitted. As such, the prediction of when a user has had the opportunity to receive one or more statements may depend on the manner in which the one or more statements have been sent to a recipient. If the one or more statements have been delivered using a method where read receipts are not possible (and/or where, e.g., predicting a time when a user will have received a statement is difficult or nearly impossible), the one or more statements may be predicted to be delivered as soon as they are transmitted. On the other hand, if the one or more statements have been delivered using a method where read receipts are available (and/or where, e.g., predicting a time when a user will have received a statement is possible), then the time when the one or more statements were actually delivered (and/or predicted to be delivered) might be considered instead.

Determining the subsets may comprise estimating whether a user has accessed an e-mail. Some statements may be delivered electronically, such as via text message, e-mail, or the like. Tracking methods may be used to determine whether those statements have been opened (by the authorized user or any user). For example, the computing device may determine that an e-mail comprising the one or more statements was opened. In effect, this may provide a better idea of whether a statement could have ever been accessed by a malicious user or not. After all, if a statement has never been opened by any user (malicious or not), then a malicious user may have never had access to the statement. Suitable tracking methods may include, for example, tracking whether a particular URL has been accessed (e.g., a URL that leads to the statement). Additionally and/or alternatively, tracking content (e.g., images) may be used in an e-mail. For example, a server-side script may be implemented such that an e-mail may retrieve an image while simultaneously passing on a unique user identifier (e.g., via a URL such as “website.com/images/image.jpg?userid=USER1”). In this way, the server may log user identifiers (e.g., “USER1”), which may thereby suggest whether an e-mail has been opened or not by those users. That said, this approach might not be ideal, as users' privacy settings (and/or privacy plugins on web browsers) may prevent such tracking from being performed. As such, it may be advantageous to require that users definitively click a link to access their statements. Additionally and/or alternatively, as indicated in the preceding paragraph, the one or more statements might be considered to be delivered as soon as they are transmitted if the one or more statements are delivered via e-mail.

Determining the subsets may comprise identifying whether one or more statements may have been stolen. In some instances, users may report malicious activity (e.g., theft of their mail, unauthorized access to their e-mail) over one or more time periods. This may indicate that one or more statements corresponding to those one or more time periods have been compromised, and transactions on those statements should not be used as the basis to generate authentication questions. Similarly, an authorized user may indicate that a particular statement has been stolen. For example, the computing device may receive an indication that the one or more statements have been stolen. In this case, as with the above, the computing device may determine that transactions on that statement should not be used as the basis to generate authentication questions.

Determining the subsets may comprise use of a machine learning model, such as one implemented via the neural network architecture 200. A machine learning model may be trained using training data comprising a history of statement mailing dates, user locations, and/or statement receipt dates. Additionally and/or alternatively, the training data may comprise a history of transaction card mailing dates, user locations, and times when such users activated their transaction cards. Based on this training, the machine learning model may be trained to predict, based on the location of a user and when a particular piece of mail (e.g., a statement) was sent, when the user may receive the particular piece of mail. In turn, whether or not a particular transaction indicated in a statement may be included in a subset may be conditioned on whether the statement is predicted to have been received by a user, which may be based on output from the trained machine learning model. For example, the computing device may provide, as input to the trained machine learning model, a statement mailing date and a location of a user. The computing device may receive, as output from the trained machine learning model, an indication of whether the user is predicted to have received the statement. If the user is predicted to have received the statement, the transaction(s) indicated in the statement may be put in their own subset of the plurality of transactions. Otherwise, the transaction(s) indicated in the statement may be put in a subset comprising transactions that have not yet been indicated in a statement.

In step 404, the computing device may generate one or more authentication questions based on the one or more subsets of the plurality of transactions. The computing device may generate a plurality of authentication questions, such that at least two or more of the plurality of authentication questions correspond to different subsets of the plurality of transactions. For example, the computing device may generate a first authentication question associated with a first transaction of the first subset of the plurality of transactions, then generate a second authentication question associated with a second transaction of the second subset of the plurality of transactions. In this manner, even if a malicious user has access to a statement, that statement may provide the malicious user the answer to only one of a plurality of authentication questions. In practice, this may prevent the malicious user from gaining access to an account using little more than a single maliciously-acquired statement.

The authentication questions may be generated such that the authentication questions relate to transactions unique to a particular subset. Different statements may comprise similar transactions. For example, an authorized user may regularly go to a coffee shop in the morning and conduct a similar transaction (e.g., order similar food/drink), such that the same or a similar transaction may be conducted repeatedly for long periods of time. In such a circumstance, it may be undesirable to ask an authentication question about such a transaction, as various different statements may all allow a malicious user to answer an authentication question. As such, the computing device may instead select transactions that are unique to a particular statement for the purposes of generating authentication questions. Uniqueness may be in terms of the merchant at which a transaction was conducted, a transaction amount, or the like. For example, the first authentication question may correspond to a first merchant that is not indicated in the second subset of the plurality of transactions, and the second authentication question may correspond to a second merchant that is not indicated in the first subset of the plurality of transactions. As another example, the first authentication question may correspond to a first amount spent at a merchant, and the second authentication question may correspond to a second amount spent at the same merchant. As yet another example, the first authentication question may relate to a first time of day when a transaction was conducted at a merchant, and the second authentication question may relate to a second time of day when a second transaction was conducted at the same merchant.

The authentication questions may be generated such that at least one authentication question relates to a trend across multiple subsets of the plurality of transactions. One way to prevent theft of a single statement from providing access to an account is to ask questions that would require knowledge of multiple statements, which (e.g., in the case of one-time mail theft) is somewhat more unlikely to occur. As such, the authentication questions may be generated such that at least one authentication question asks about a trend across multiple subsets of the plurality of transactions, such as where an authorized user commonly shops every month, where the authorized user shops at the beginning of each month, or the like. Additionally and/or alternatively, authentication questions may be generated such that at least one authentication question relates to transactions that an authorized user used to conduct, but no longer conducts. For example, if a user regularly shops at a particular store during the summer but not during the winter, one authentication question may prompt the user to identify which store(s) they shop at during the summer. In this manner, if a malicious user were to steal a statement associated with a winter month, that statement would not allow the malicious user to answer the question. Moreover, even if a malicious user were to steal a statement associated with a summer month, the single statement alone would not necessarily evince the trend.

In step 405, the computing device may receive one or more candidate responses to the authentication questions. A candidate response may be any indication of a response, by a user, to the one or more authentication questions generated in step 404. For example, the computing device may receive a first candidate response to the first authentication question and receive a second candidate response to the second authentication question. Where an authentication question comprises one or more predetermined answers (e.g., options from which a user can select), a candidate response may comprise a selection of at least one of the one or more predetermined answers. Additionally and/or alternatively, the candidate response may comprise entry of text, such as a dollar figure and/or the name of a merchant. In the case of a telephone call, the candidate response may comprise an oral response to an authentication question provided using a text-to-speech system over the call.

In step 406, the computing device may determine whether the one or more candidate responses received are correct. Determining whether the one or more candidate responses are correct may comprise comparing the candidate response to the correct answer(s) to the one or more authentication questions generated in step 404. This process may entail determining whether a quantity of correct answers satisfies a threshold, such that a user need not answer all questions correctly for the answer to step 406 to be yes. Such a threshold may be based on the difficulty of the authentication questions presented: for example, if the questions are particularly difficult, a relatively lower threshold may be implemented. If the one or more candidate answers are correct (e.g., if a quantity of the one or more candidate answers that are correct satisfy a threshold), the method 400 may proceed to step 407. Otherwise, if an insufficient number of candidate responses are correct (e.g., if a quantity of the one or more candidate answers that are correct do not satisfy a threshold), the method 400 may end.

In step 407, the computing device may provide access to the account. For example, the computing device may provide, based on the first candidate response and the second candidate response, the user device access to the account. Access to the account may be provided by, e.g., providing a user device access to a protected portion of a website, transmitting confidential data to a user device, allowing a user to request, modify, and/or receive personal data (e.g., from the user account database 304 and/or the transactions database 303), or the like.

The process depicted by the method 400 may be repeated for any number of authentication questions. For example, even though many of the examples above discuss two authentication questions for the purposes of simplicity, three or more authentication questions may be implemented. For instance, the computing device may determine that a third subset of the plurality of transactions were indicated in one or more second statements sent to the user. Those one or more second statements may correspond to a different time period as compared to the one or more statements. Then, the computing device may generate a third authentication question associated with a third transaction of the third subset of the plurality of transactions. Then, the computing device may receive a third candidate response to the third authentication question, wherein the instructions, when executed by the one or more processors, cause the computing device to provide the user device access to the account further based on the third candidate response.

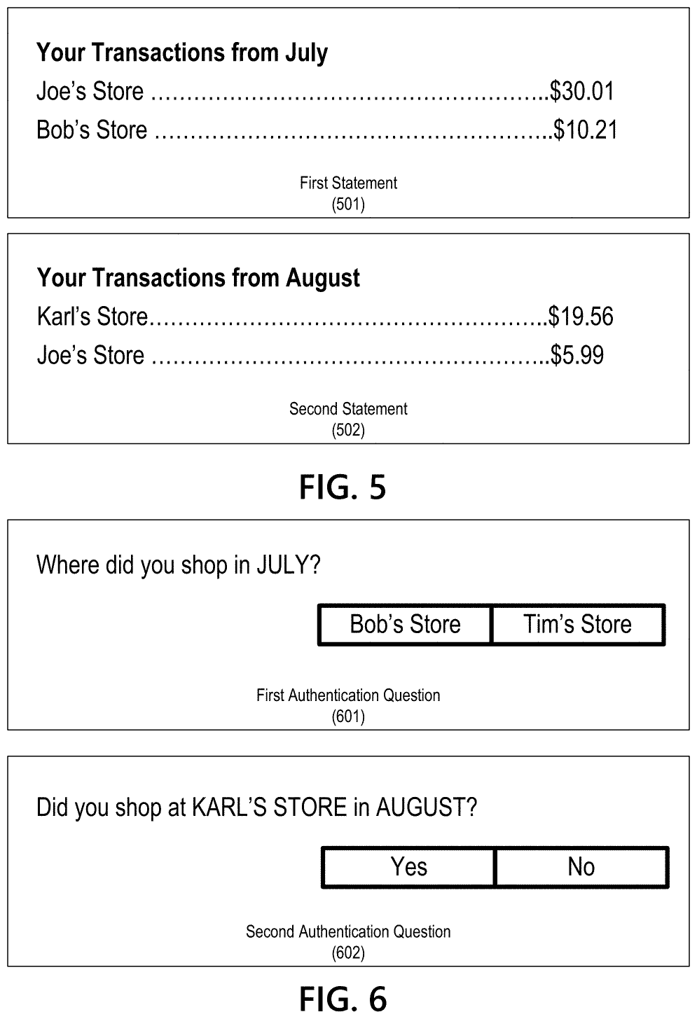

FIG. 5 depicts examples of statements, including a first statement 501 and a second statement 502. The statements depicted in FIG. 5 may be electronic or printed statements, such as may be provided using physical mail, e-mail, text messages, or the like. The first statement 501 shows two transactions from July: a first transaction at Joe's Store for $30.01, and a second transaction at Bob's Store for $10.21. The second statement 502 shows two transactions from August: a first transaction at Karl's Store for $19.56, and a second transaction at Joe's Store at $5.99. Note that the first statement 501 and second statement 502 both identify a common merchant (Joe's Store) while also identifying unique merchants (Bob's Store for the first statement 501 and Karl's Store for the second statement 502).

FIG. 6 depicts examples of authentication questions that have been generated based on the first statement 501 and the second statement 502 of FIG. 5, including a first authentication question 601 and a second authentication question 602. The first authentication question 601 is shown inquiring as to where a user shopped in July. As indicated by the potential answers in the first authentication question 601, one answer may be correct (Bob's Store), whereas one or more answers (e.g., Tim's Store) may be incorrect. The second authentication question 602 is shown asking a user whether they shopped at Karl's Store in August, with possible answers “Yes” and “No.” As indicated by the first authentication question 601 and the second authentication question 602, it may be desirable to have authentication questions pertain to content from different statements. As such, if a malicious user were to steal the first statement 501 of FIG. 5, then the malicious user may be able to answer the first authentication question 601, but might not be able to answer the second authentication question 602.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing device comprising:
one or more processors; and
memory storing instructions that, when executed by the one or more processors, cause the one or more processors to perform the steps of:
receiving, from a user device, a request for access to an account associated with a user,
receiving, from a transactions database, transactions data corresponding to the account, wherein the transactions data comprises a list of a plurality of transactions conducted by the user;
determining that a first subset of the plurality of transactions were part of a second list of transactions provided in one or more mailed bank statements sent to the user;
determining that a second subset of the plurality of transactions that are different from any of the transactions of the second list of transactions provided in the one or more mailed bank statements sent to the user;
generating a first authentication question associated with a first transaction of the first subset of the plurality of transactions, wherein the first authentication question relates to information provided in the one or more mailed bank statements sent to the user;
generating a second authentication question associated with a second transaction of the second subset of the plurality of transactions, wherein the second authentication question relates to information not provided in the one or more mailed bank statements sent to the user;
receiving a first candidate response to the first authentication question;
receiving a second candidate response to the second authentication question; and
providing based on the first candidate response and the second candidate response, the user device access to the account.

2. The computing device of claim 1, wherein the instructions, when executed by the one or more processors, cause the one or more processors to perform the step of determining that the first subset of the plurality of transactions were part of the second list of transactions provided in the one or more mailed bank statements sent to the user by causing the one or more processors to perform the step of:
estimating, based on average physical mail delivery times associated with a location of the user, that the user has received the one or more mailed bank statements.

3. The computing device of claim 2, wherein the instructions, when executed by the one or more processors, cause the one or more processors to perform the step of estimating that the user has received the one or more mailed bank statements by:
determining a mailing time of a transaction card;
determining an activation time of the transaction card;
determining, based on comparing the mailing time and the activation time, a mailing delay;
determining a second mailing time associated with the one or more mailed bank statements; and
determining, based on comparing the second mailing time and the mailing delay, that the user has received the one or more mailed bank statements.

4. The computing device of claim 1, wherein the instructions, when executed by the one or more processors, cause the one or more processors to perform the step of determining that the first subset of the plurality of transactions were part of the second list of transactions provided in the one or more mailed bank statements sent to the user by:
determining that an e-mail comprising the one or more mailed bank statements was opened based on determining whether a tracking image contained in the e-mail was accessed.

5. The computing device of claim 1, wherein the instructions, when executed by the one or more processors, cause the one or more processors perform the step of determining that the first subset of the plurality of transactions were part of the second list of transactions provided in the one or more mailed bank statements sent to the user by:
receiving, from the user, an indication that the one or more mailed bank statements have been stolen.

6. The computing device of claim 1, wherein the first authentication question corresponds to a first merchant that is not associated with any transactions of the second subset of the plurality of transactions, and wherein the second authentication question corresponds to a second merchant that is not associated with any transactions of the first subset of the plurality of transactions.

7. The computing device of claim 1, wherein the instructions, when executed by the one or more processors, further cause the one or more processors to perform the steps of:
determining that a third subset of the plurality of transactions were part of the second list of transactions provided in one or more second mailed bank statements sent to the user, wherein the one or more second mailed bank statements correspond to a different time period as compared to the one or more mailed bank statements;
generating a third authentication question associated with a third transaction of the third subset of the plurality of transactions; and
receiving a third candidate response to the third authentication question, wherein the instructions, when executed by the one or more processors, cause the computing device to provide the user device access to the account further based on the third candidate response.

8. The computing device of claim 1, wherein the one or more mailed bank statements comprise one or more of:
paper statements mailed to the user; or
electronic statements transmitted to the user.

9. A computer-implemented method comprising:
receiving, by a computing device and from a user device, a request for access to an account associated with a user;
receiving, by the computing device and from a transactions database, transactions data corresponding to the account, wherein the transactions data comprises a list of a plurality of transactions conducted by the user;
determining, by the computing device, that a first subset of the plurality of transactions were part of a second list of transactions provided in one or more mailed bank statements sent to the user;
determining, by the computing device, that a second subset of the plurality of transactions that are different from any of the transactions of the second list of transactions provided in the one or more mailed bank statements sent to the user;
generating, by the computing device, a first authentication question associated with a first transaction of the first subset of the plurality of transactions, wherein the first authentication question relates to information provided in the one or more mailed bank statements sent to the user;
generating, by the computing device, a second authentication question associated with a second transaction of the second subset of the plurality of transactions, wherein the second authentication question relates to information not provided in the one or more mailed bank statements sent to the user;
receiving, by the computing device, a first candidate response to the first authentication question;
receiving, by the computing device, a second candidate response to the second authentication question; and
providing, by the computing device and based on the first candidate response and the second candidate response, the user device access to the account.

10. The method of claim 9, wherein determining that the first subset of the plurality of transactions were part of the second list of transactions provided in the one or more mailed bank statements sent to the user comprises:
estimating, by the computing device and based on average physical mail delivery times associated with a location of the user, that the user has received the one or more mailed bank statements.

11. The method of claim 10, wherein estimating that the user has received the one or more mailed bank statements comprises:
determining, by the computing device, a mailing time of a transaction card;
determining, by the computing device, an activation time of the transaction card;
determining, by the computing device and based on comparing the mailing time and the activation time, a mailing delay;
determining, by the computing device, a second mailing time associated with the one or more mailed bank statements; and
determining, by the computing device and based on comparing the second mailing time and the mailing delay, that the user has received the one or more mailed bank statements.

12. The method of claim 9, wherein determining that the first subset of the plurality of transactions were part of the second list of transactions provided in the one or more mailed bank statements sent to the user comprises:
determining, by the computing device, that an e-mail comprising the one or more mailed bank statements was opened based on determining whether a tracking image contained in the e-mail was accessed.

13. The method of claim 9, wherein determining that the first subset of the plurality of transactions were part of the second list of transactions provided in the one or more statements sent to the user comprises:
receiving, by the computing device and from the user, an indication that the one or more mailed bank statements have been stolen.

14. The method of claim 9, wherein the first authentication question corresponds to a first merchant that is not associated with any transactions of the second subset of the plurality of transactions, and wherein the second authentication question corresponds to a second merchant that is not associated with any transactions of the first subset of the plurality of transactions.

15. The method of claim 9, further comprising:
determining, by the computing device, that a third subset of the plurality of transactions were part of the second list of transactions provided in one or more second mailed bank statements sent to the user, wherein the one or more second mailed bank statements correspond to a different time period as compared to the one or more mailed bank statements;
generating by the computing device, a third authentication question associated with a third transaction of the third subset of the plurality of transactions; and
receiving, by the computing device, a third candidate response to the third authentication question, wherein providing the user device access to the account is further based on the third candidate response.

16. The method of claim 9, wherein the one or more mailed bank statements comprise one or more of:
paper statements mailed to the user; or
electronic statements transmitted to the user.

17. One or more non-transitory computer-readable media storing instructions that, when executed by one or more processors of a computing device, cause the one or more processors to perform the steps of:
receiving, from a user device, a request for access to an account associated with a user;
receiving, from a transactions database, transactions data corresponding to the account, wherein the transactions data comprises a list of a plurality of transactions conducted by the user;
determining that a first subset of the plurality of transactions were part of a second list of transactions provided in one or more mailed bank statements sent to the user;
determining that a second subset of the plurality of transactions that are different from any of the transactions of the second list of transactions provided in the one or more mailed bank statements sent to the user;
generating a first authentication question associated with a first transaction of the first subset of the plurality of transactions, wherein the first authentication question relates to information provided in the one or more mailed bank statements sent to the user;
generating a second authentication question associated with a second transaction of the second subset of the plurality of transactions, wherein the second authentication question relates to information not provided in the one or more mailed bank statements sent to the user;
receiving a first candidate response to the first authentication question;
receiving a second candidate response to the second authentication question; and
providing, based on the first candidate response and the second candidate response, the user device access to the account.

18. The one or more non-transitory computer-readable media of claim 17, wherein the instructions, when executed by the one or more processors, cause the one or more processors to perform the step of determining that the first subset of the plurality of transactions were part of the second list of transactions provided in the one or more mailed bank statements sent to the user by causing the one or more processors to perform the step of:
predicting, based on average physical mail delivery times associated with a location of the user, that the user has received the one or more mailed bank statements.

19. The one or more non-transitory computer-readable media of claim 17, wherein the instructions, when executed by the one or more processors, cause the one or more processors to perform the step of predicting that the user has received the one or more mailed bank statements by causing the one or more processors to perform the steps of:
determining a mailing time of a transaction card;
determining an activation time of the transaction card;
determining, based on comparing the mailing time and the activation time, a mailing delay;
determining a second mailing time associated with the one or more mailed bank statements; and
determining, based on comparing the second mailing time and the mailing delay, that the user has received the one or more mailed bank statements.

20. The one or more non-transitory computer-readable media of claim 17, wherein the instructions, when executed by the one or more processors, cause the one or more processors to perform the step of determining that the first subset of the plurality of transactions were part of the second list of transactions provided in the one or more mailed bank statements sent to the user by causing the one or more processors to perform the step of:
determining that an e-mail comprising the one or more mailed bank statements was opened based on determining whether a tracking image contained in the e-mail was accessed.
